(19) United States
(12) Patent Application Publication
(10) Pub. No.: US 2013/0182626 A1
(43) Pub. Date: Jul. 18, 2013

(54) METHOD AND APPARATUS FOR REDUCING USER EQUIPMENT (UE) POWER CONSUMPTION IN THE RRC (RADIO RESOURCE CONTROL) CONNECTED MODE

(71) Applicant: INNOVATIVE SONIC CORPORATION, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 13/738,301

(22) Filed: Jan. 10, 2013

Related U.S. Application Data
(60) Provisional application No. 61/586,255, filed on Jan. 13, 2012.

(51) Int. Cl. H04W 52/02

(52) U.S. Cl. CPC H04W 52/02
USPC 370/311

(57) ABSTRACT

A method and apparatus are disclosed for reducing UE power consumption in the RRC connected mode. The method includes the UE entering a dormant state in which the UE does not monitor PDCCH (Physical Downlink Control Channel) scheduling during On_Durations. The method also includes the UE leaving the dormant state upon reception of a paging message with a specific indication, such as downlink data arrival or transmission.

### CROSS-REFERENCE TO RELATED APPLICATIONS

The present Application claims the benefit of U.S. Provisional Patent Application Ser. No. 61/586,255 filed on Jan. 13, 2012, the entire disclosure of which is incorporated herein by reference.

### FIELD

This disclosure generally relates to wireless communication networks, and more particularly, to a method and apparatus for reducing UE (User Equipment) power consumption in the RRC (Radio Resource Control) connected mode.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for reducing the UE power consumption in the RRC connected mode. The method includes the UE entering a dormant state in which the UE does not monitor PDCCH (Physical Downlink Control Channel) scheduling during On_Durations. The method also includes the UE leaving the dormant state upon reception of a paging message with a specific indication, such as downlink data arrival or transmission.

### BRIEF DESCRIPTION OF THE DRAWINGS

FIG. 1 shows a diagram, of a wireless communication system according, to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 recording to one exemplary embodiment.

FIG. 5 is a state transition diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA) 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed, to support one or more standards such as the standard offered by a consortium named “3rd Generation Partnership Project” referred to herein as 3GPP, including Document Nos. TS 22.368 v11.3.0, “Service requirements for Machine-Type Communications Stage 1 (Release 11)”; RP-111112, “Provision of low-cost MTC UEs based on LTE”; TS 36.331 v10.4.0, “RRC protocol specification (Release 10)”; TS 36.304 v10.4.0, “User Equipment (UE) procedures in idle mode (Release 10)”; TS 36.321 v10.4.0, “MAC protocol specification (Release 10)”; R1-114245, “Standards aspects impacting low-cost MTC UEs”; R1-113683, “Standards aspects impacting UE costs”. The standards and documents listed above are hereby expressly incorporated herein.

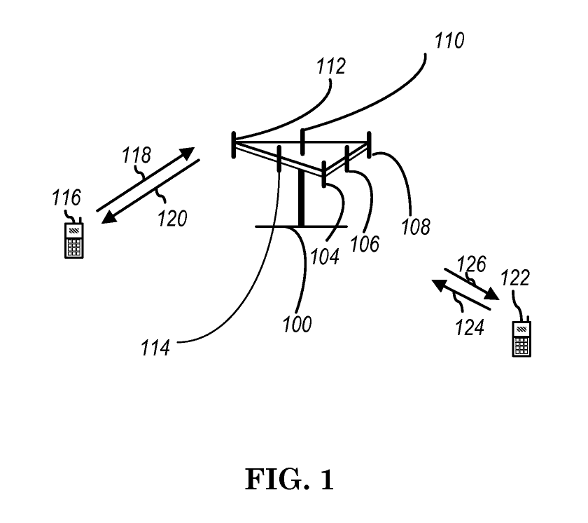

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

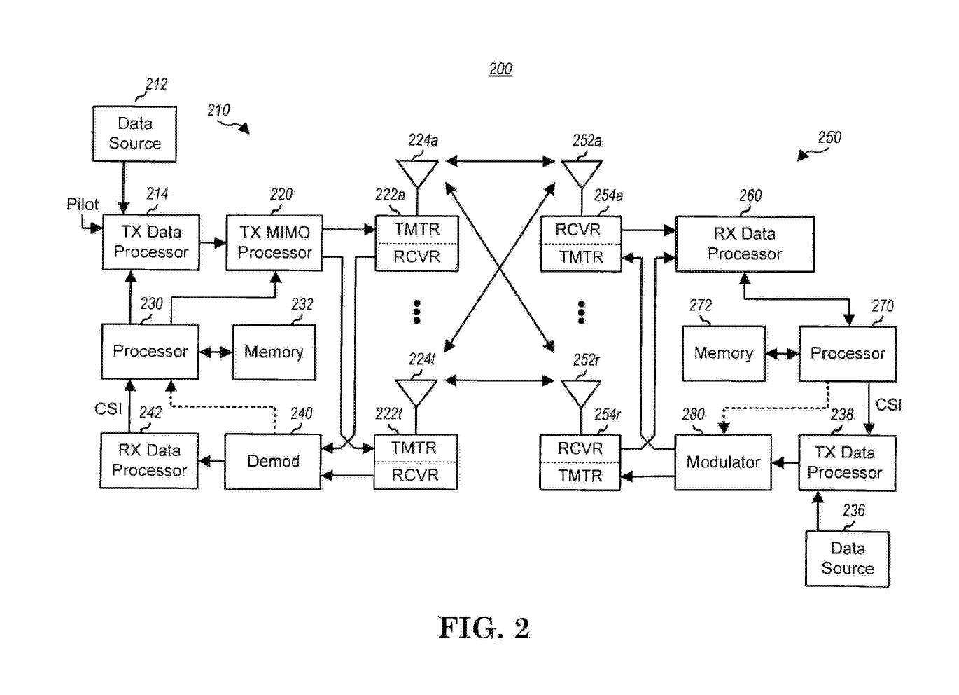

FIG. 2 is a simplified block diagram of an embodiment of a transmitter system 210 (also known, as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based or a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog; signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, tire modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

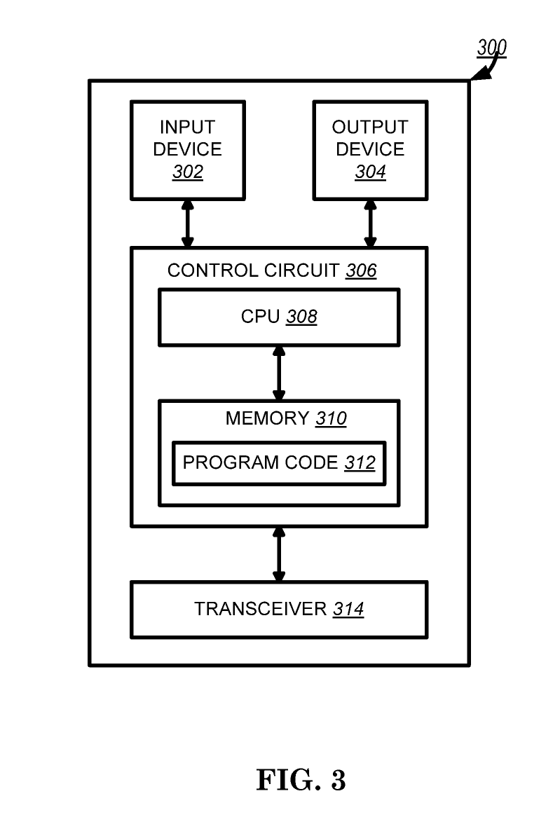

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

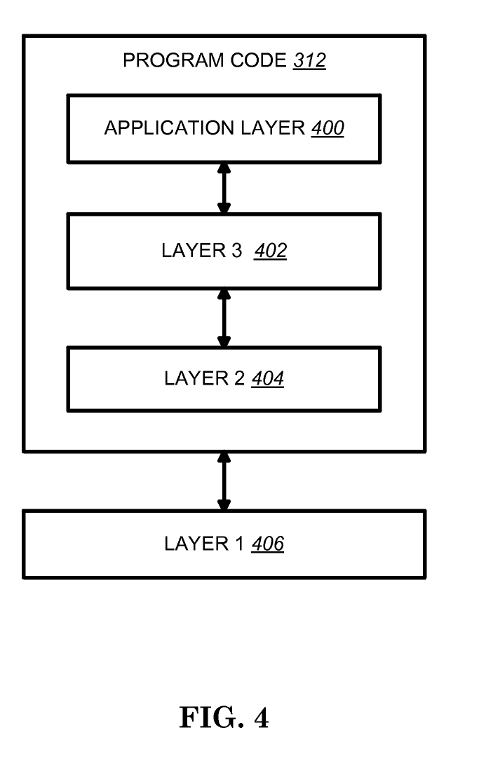

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

MTC (Machine Type Communication) is generally a form of data communication which involves one or more entities that do not necessarily need human interaction. A service optimized for machine type communications may differ from a service optimized for Human-to-Human communication.

3GPP TS 22.368 specifies the service requirements for Network Improvements for Machine Type Communications, which include service requirements common to all MTC Devices and service requirements specific to certain MTC Devices (called MTC features). 3GPP TS 22.368 describes the MTC Device, MTC Group, and MTC Server as follows:

MTC Device: A MTC Device is a UE equipped for Machine Type Communication, which communicates through a PLMN with MTC Server(s) and/or other MTC Device(s).

MTC Group: A MTC Group is a group of MTC Devices that share one or more MTC Features and that belong to the same MTC Subscriber.

MTC Server: A MTC Server is a server, which communicates to the PLMN itself, and to MTC Devices through the PLMN. The MTC Server also has an interface which can be accessed by the MTC User. The MTC Server performs services for the MTC User.

Regarding power consumption, 3GPP TS 22.368 requires that the system shall provide mechanisms to lower power consumption of MTC Devices. According to 3GPP TS 22.368, MTC Devices may or may not be kept attached to the network when not communicating, depending on operator policies and MTC Application requirements. In addition, MTC Devices may keep their data connection or not keep their data connection when not communicating, depending on operator policies and MTC Application requirements.

3GPP RP-111112 describes a study item for low-cost MTC Devices based on Long Term Evolution (LTE). In general, power consumption would be considered a critical issue for the low-cost MTC Devices.

The LTE RRC specification (3GPP TS 36.331) describes the purpose of a paging procedure as follows;

### 5.3.2 Paging

### 5.3.2.1 General

[ . . . ]
The purpose of this procedure is:
to transmit paging information to a UE in RRC_IDLE and/or;
to inform UEs in RRC_IDLE and UEs in RRC_CONNECTED about a system information change and/or;
to inform about an ETWS primary notification and/or ETWS secondary notification and/or;
to inform about a CMAS notification.
   The paging information is provided to upper layers, which in response may initiate RRC connection establishment, e.g. to receive an incoming call.

### 5.3.2.2 Initiation

E-UTRAN initiates the paging procedure by transmitting the Paging message at the UE's paging occasion as specified in TS 36.304 [4]. E-UTRAN may address multiple UEs within a Paging message by including one PagingRecord for each UE. E-UTRAN may also indicate a change of system information, and/or provide an ETWS notification or a CMAS notification in the Paging message.
[ . . . ]

The paging occasions on which the UE monitors paging message are defined in 3GPP TS 36.304 as follows:

### 7 Paging

### 7.1 Discontinuous Reception for Paging

The UE may use Discontinuous Reception (DRX) in idle mode in order to reduce power consumption. One Paging Occasion (PO) is a subframe where there may be P-RNTI transmitted on PDCCH addressing the paging message. One Paging Frame (PF) is one Radio Frame, which may contain one or multiple Paging Occasion(s). When DRX is used the UE heeds only to monitor one PO per DRX cycle. PF and PO is determined by following formulae using the DRX parameters provided in System Information:
PF is given by following equation:

SFN mod T=(T div N)*(UE_{—}ID mod N)

Index i_s pointing to PO from subframe pattern defined in 7.2 will be derived from following calculation:

i_{—}s=floor(UE_{—}ID/N) mod Ns

System Information DRX parameters stored in the UE shall be updated locally in the UE whenever the DRX parameter values are changed in SI. If the UE has no IMSI, for instance when making an emergency call without USIM, the UE shall use as default identity UE_ID=0 in the PF and i_s formulas above.
The following Parameters are used for the calculation of the PF and i_s:
T: DRX cycle of the UE. T is determined by the shortest of the UE specific DRX value, if allocated by upper layers, and a default DRX value broadcast in system information. If UE specific DRX is not configured by upper layers, the default value is applied.
nB: 4T, 2T, T, T/2, T/4, T/8, T/16, T/32,
N: min(T,nB)
Ns: max(1,nB/T)
UE_ID: IMSI mod 1024.
   IMSI is given as sequence of digits of type integer (0.9), IMSI shall in the formulae above be interpreted as a decimal integer number, where the first digit given in the sequence represents the highest order digit.
   For example:

IMSI=12(digit1, digit2=2)

In the calculations, this shall be interpreted as the decimal integer “12”, not “1×16+2=8”.

### 7.2 Subframe Patterns

### FDD:

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

### TDD (all UL/DL Configurations):

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

For power saving, 3GPP TS 36.321 specifies discontinuous reception (DRX) functionality for UEs in connected mode as follows:

### 5.7 Discontinuous Reception (DRX)

The UE may be configured by RRC with a DRX functionality that controls the UE's PDCCH monitoring activity for the UE's C-RNTI, TPC-PUCCH-RNTI, TPC-PUSCH-RNTI and Semi-Persistent Scheduling C-RNTI (if configured). When in RRC_CONNECTED, if DRX is configured, the UE is allowed to monitor the PDCCH discontinuously using the DRX operation specified in this subclause; otherwise the UE monitors the PDCCH continuously. When using DRX operation, the UE shall also monitor PDCCH according to requirements found in other subclauses of this specification. RRC controls DRX operation by configuring the timers onDurationTimer, drx-InactivityTimer, drx-RetransmissionTimer (one per DL HARQ process except for the broadcast process), the longDRX-Cycle, the value of the drxStartOffset and optionally the drxShortCycleTimer and shortDRX-Cycle, A HARQ RTT timer per DL HARQ process (except for the broadcast process) is also defined (see subclause 7.7).
When a DRX cycle is configured, the Active Time includes the time while:
onDurationTimer or drx-InactivityTimer or drx-RetransmissionTimer or mac-ContentionResolutionTimer (as described in subclause 5.1.5) is running; or
a Scheduling Request is sent on PUCCH and is pending (as described in subclause 5.4.4); or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble, not selected by the UE (as described in subclause 5.1.4).
   When DRX is configured, the UE shall for each subframe:
if a HARQ RTT Timer expires in this subframe and the data of the corresponding HARQ process was not successfully decoded:
   start the drx-Retransmission Timer for the corresponding HARQ process.
if a DRX Command MAC control element is received:
   stop onDurationTimer;
   stop drx-InactivityTimer.
if drx-InactivityTimer expires or a DRX Command MAC control element is received in this subframe:
   if the Short DRX cycle is configured:
      start or restart drxShortCycleTimer;
      use the Short DRX Cycle.
   else;
      use the long DRX cycle.
if drxShortCycleTimer expires in this subframe:
   use the Long DRX cycle.
If the Short DRX Cycle is used and [(SFN*10)+subframe number] modulo (shortDRX-Cycle)=(drxStartOffset) modulo (startDRX-Cycle); or
if the Long DRX Cycle is used and [(SFN*10)+subframe number] modulo (longDRX-Cycle)=drxStartOffset:
   start onDurationTimer.
during the Active Time, for a PDCCH-subframe, if the subframe is not required for uplink transmission for half-duplex FDD UE operation and if the subframe is not part of a configured measurement gap:
   monitor the PDCCH;
if the PDCCH indicates a DL transmission or if a DL assignment has been configured for this subframe:
   start the HARQ RTT Timer for the corresponding HARQ process;
   stop the drx-RetransmissionTimer for the corresponding HARQ process.
if the PDCCH indicates a new transmission (DL or UL):
   start or restart drx-InactivityTimer.
when not in Active Time, type-0-triggered SRS [2] shall not be reported.
if CQI masking (cqi-Mask) is setup by upper layers:
   when onDurationTimer is not running, CQI/PMI/RI/PTI on PUCCH shall not be reported.
else:
   when not in Active Time, CQI/PMI/RI/PTI on PUCCH shall not be reported.
      Regardless of whether the UE is monitoring PDCCH or not the UE receives and transmits HARQ feedback and transmits type-1-triggered SRS [2] when such is expected.

In general regarding power consumption, 3GPP TS 22.368 requires that the system shall provide mechanisms to lower power consumption of MTC Devices. 3GPP TS also 22.368 proposes that MTC Devices may or may not be kept attached to the network when not communicating, depending on operator policies and MTC Application requirements. As such, the RRC connection of an MTC Device may or may not be released after data transfer has been finished.

One benefit of releasing the RRC connection would be to avoid UE power consumption due to PDCCH (Physical Downlink Control Channel) monitoring in RRC connected mode when there is no data for transmission. However, there is some signaling overhead for the UE to establish the RRC connection again for the next data transfer, which is not efficient in terms of resource usage if the data packet is small. Therefore, for some situations it may be beneficial to still keep the MTC Device in RRC connected mode.

Regarding power saving for MTC Devices, 3GPP R1-114245 proposes to apply longer DRX cycle and longer paging cycle. Other methods may be considered for further UE power consumption reduction in RRC connected mode.

Since the paging occasions (as specified in 3GPP TS36.304) and the On_Durations value (as specified in 3GPP TS36.321) are determined by different parameters, they would typically occur at different time instances. Thus, one way of reducing UE power consumption would be to align the paging occasions with the On_Durations value so that the UE could monitor both paging and PDCCH scheduling at the same time (such as through the same subframe). To be more specific, the UE monitors PDCCH would address both P-RNTI (Paging Radio Network Temporary Identifier) for paging and C-RNTI (Cell Radio Network Temporary Identifier) for scheduling on the paging occurrences (or occasions), wherein the UE would monitor one paging occurrence (or occasion) per paging cycle.

In addition, there may be one or multiple paging occurrence(s) in a paging frame (PF). The paging occurrence (or occasion) for the UE to monitor may be determined by an index calculated by UE identity and paging related parameters (such as nB) included in system information (such as System Information Block Type 2—SIB2). Optionally, the UE may freely select a paging occurrence (or occasion) to monitor from a set of available paging occurrences in a paging frame. In addition, the paging cycle may be equal to a default paging cycle included in SIB2 or a UE specific paging cycle configured by the network via upper layer or via RRC signaling. The paging cycle may also be determined by the shorter value of the default paging cycle and the UE specific paging cycle.

Another alternative would be when the drx-InactivityTimer expires or when the UE finishes data transfer, the UE would enter a dormant state, in which the UE does not need to monitor PDCCH scheduling during On_Duration. In addition, a paging message would be used to instruct the UE to start monitoring PDCCH scheduling again during the On_Durations (for example, the UE leaves the dormant state upon reception of a paging message with a specific indication, such as downlink data arrival/transmission). Furthermore, the UE may also leave the dormant state when a Scheduling Request (SR) is triggered in the UE or when the UE receives a PDCCH indicating a new transmission.

In one embodiment, the UE may determine that data transfer is finished if the uplink HARQ (Hybrid Automatic Repeat reQuest) buffer is empty and if the drx-InactivityTimer, all drx-RetransmissionTimers, and all HARQ RTT (Round Trip Time) timers are not running.

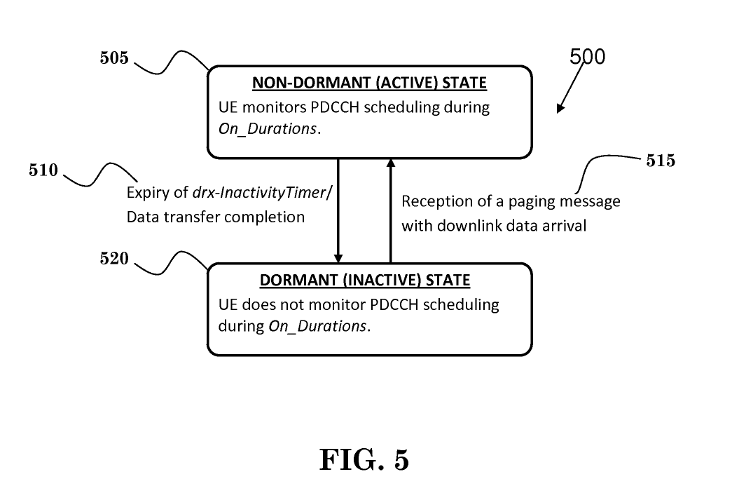

FIG. 5 illustrates a state transition diagram 500 according to one exemplary embodiment. As shown in FIG. 5, in the non-dormant (or active) state 505, the UE would monitor PDCCH scheduling during On_Durations. However, in the dormant (or inactive) state 520, the UE does not monitor PDCCH scheduling during On_Durations. Furthermore, the UE would transition from the non-dormant (or active) state 505 to the dormant (or inactive) state 520 when certain events occur (such as when the drx_InactivityTimer expires or when the data transfer has been completed) 510. In addition, the UE would transition from the dormant (or inactive) state 520 to the non-dormant (or active) state 505 when, for example, the UE receiver a paging message indicating downlink data arrival 515.

Referring back to FIGS. 3 and 4, the UE 300 includes a program code 312 stored in memory 310. In one embodiment, the CPU 308 could execute the program code 312 to monitor a PDCCH (Physical Downlink Control Channel) for a paging message and a scheduling information at the same time or the same subframe. In this embodiment, the UE is in a RRC connected mode, and would monitor the PDCCH addressed to a P-RNTI and a C-RNTI on each paging occurrence or occasion. Furthermore, the UE would monitor one paging occurrence per paging cycle. The paging occurrence being monitored may be determined by an index calculated by a UE identity and page related parameters (such as SIB2—System Information Block Type 2). The UE may freely select the paging occurrence to monitor from a set of available paging occurrences in a paging frame. In addition, the paging cycle may be equal to a default paging cycle included in a SIB2 or in a UE specific paging cycle configured by the network via upper layer or via RRC signaling. The paging cycle may also be determined by the shorter of (i) the default paging cycle and (ii) the UE specific paging cycle.

In one embodiment, the CPU 308 could execute the program code 312 (i) to enter a dormant state in which the UE does not monitor PDCCH scheduling during On_Durations, and (ii) to leave the dormant state upon reception of a paging message with a specific indication, such as downlink data arrival or transmission. In this embodiment, the UE is in a RRC connected mode, and would: monitoring PDCCH scheduling during On_Durations after leaving the dormant state. In general, the On_Durations is a time period during which an onDurationTimer is running. The onDurationTimer could be started according to a System Frame Number (SFN), a DRX (Discontinous Reception) cycle, and a drxStartOffset.

In one embodiment, the UE would leave the dormant state when a Scheduling Request (SR) is triggered in the UE or when the UE receives a PDCCH indicating a new transmission. Furthermore, the UE would enter the dormant state when a drx-InactivityTimer expires or when the UE finishes data transfer. In addition, the UE would determine that data transfer is finished if uplink HARQ (Hybrid Automatic Repeat request) buffer is empty and if a drx-InactivityTimer, all drx-RetransmissionTimers, and all HARQ RTT (Round Trip Time) timers are not running.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been, described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted a causing a departure from the scope of the present disclosure.

In addition, the various; illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium, may be integral to the processor. The processor and the storage medium may reside in an ASIC. The ASIC may reside in user equipment. In the alternative, the processor and the storage medium, may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for reducing power consumption in a user equipment (UE) wherein the UE is in a RRC (Radio Resource Control) connected mode, comprising:
monitoring, at the UE, a PDCCH (Physical Downlink Control Channel) for a paging message and a scheduling information at the same time or the same subframe.

2. The method of claim 1, wherein the UE monitors the PDCCH addressed to a P-RNTI (Paging Radio Network Temporary Identifier) and a C-RNTI (cell Radio Network Temporary Identifier) on each paging occurrence.

3. The method of claim 2, wherein the UE monitors one paging occurrence per paging cycle, and the paging occurrence being monitored may be determined by an index calculated by a UE identity and page related parameters including a system information, such as SIB2 (System Information Block Type 2).

4. The method of claim 3, wherein the paging cycle may be equal to a default paging cycle included in a SIB2 or in a UE specific paging cycle configured by the network via upper layer or via RRC signaling, or the paging cycle may be determined by the shorter of the default paging cycle and the UE specific paging cycle.

5. The method of claim 2, wherein the UE may freely select the paging occurrence to monitor from a set of available paging occurrences in a paging frame.

6. A communication device for reducing power consumption in a user equipment (UE), wherein the UE is in a RRC (Radio Resource Control) connected mode, the communication device comprising:
a control circuit;
a processor installed in the control circuit;
a memory installed in the control circuit and operatively coupled to the processor;
wherein the processor is configured to execute a program code stored in memory to reducing power consumption by:
monitoring, at the UE, a PDCCH (Physical Downlink Control Channel) for a paging message and a scheduling information at the same time or the same subframe.

7. The communication device of claim 6, wherein the UE monitors the PDCCH addressed to a P-RNTI (Paging Radio Network Temporary Identifier) and a C-RNTI (cell Radio Network Temporary Identifier) on each paging occurrence.

8. The communication device of claim 7, wherein the UE monitors one paging occurrence per paging cycle, and the paging occurrence being monitored may be determined by an index calculated by a UE identity and page related parameters including a system information, such as a SIB2 (System Information Block Type 2).

9. The communication device of claim 8, wherein the paging cycle may be equal to a default paging cycle included in the SIB2 or in a UE specific paging cycle configured by the network via upper layer or via RRC signaling, or the paging cycle may be determined by the shorter of the default paging cycle and the UE specific paging cycle.

10. The communication device of claim 7, wherein the UE may freely select the paging occurrence to monitor from a set of available paging occurrences in a paging frame.

11. A method for reducing power consumption in a user equipment (UE) wherein the UE is in a RRC (Radio Resource Control) connected mode, comprising:
the UE entering a dormant state in which the UE does not monitor PDCCH (Physical Downlink Control Channel) scheduling during On_Durations; and
the UE leaving the dormant state upon reception of a paging message with a specific indication, such as downlink data arrival or transmission.

12. The method of claim 11, further comprises:
the UE monitoring PDCCH scheduling during On_Durations after leaving the dormant state, wherein the On_Durations is a time period during which an On_DurationTimer is running.

13. The method of claim 12, wherein the On_DurationTimer is started according to a System Frame Number (SFN), a DRX (Discontinuous Reception) cycle, and a drxStartOffset.

14. The method of claim 11, wherein the UE leaves the dormant state when a Scheduling Request (SR) is triggered in the UE or when the UE receives a PDCCH indicating a new transmission.

15. The method of claim 11, wherein the UE enters the dormant state when a drx-InactivityTimer expires or when the UE finishes data transfer.

16. The method of claim 15, wherein the UE determines that data transfer is finished if uplink HARQ (Hybrid Automatic Repeat request) buffer is empty and if a drx-InactivityTimer, all drx-RetransmissionTimers, and all HARQ RTT (Round Trip Time) timers are not running.

17. A communication device for reducing, power consumption in a user equipment (UE), wherein the UE is in a RRC (Radio Resource Control) connected mode, the communication device comprising:
a control circuit;
a processor installed in the control circuit;
a memory installed in the control circuit and operatively coupled to the processor;
wherein the processor is configured to execute a program code stored in memory to reducing power consumption by:
the UE entering a dormant state in which the UE does not monitor PDCCH (Physical Downlink Control Channel) scheduling during On_Durations; and
the UE leaving tire dormant state upon reception of a paging message with a specific indication, such as downlink data arrival or transmission.

18. The communication device of claim 17, wherein the UE monitors PDCCH scheduling during On_Durations after leaving the dormant state, wherein the On_Duration is a time period during which an onDurationTimer is running.

19. The communication device of claim 17, wherein the UE leaves the dormant state when a Scheduling Request (SR) is triggered in the UE or when the UE receives a PDCCH indicating a new transmission.

20. The communication device of claim 17, wherein the UE enters the dormant state when a drx-InactivityTimer expires or when the UE finishes data transfer.
